(19) United States
(12) Patent Application Publication
(10) Pub. No.: US 2018/0155246 A1
(43) Pub. Date: Jun. 7, 2018

(54) INSULATED CONCRETE FORMS, INSULATING CEMENT, AND RELATED ARTICLES PRODUCED THEREFROM

(71) Applicant: Thermacrete Industries, LLC, Waldport, OR (US)

(72) Inventors: Frank Prante, Waldport, OR (US); Mitch Henderson, Logan, UT (US)

(73) Assignee: Thermacrete Industries, LLC, Waldport, OR (US)

(21) Appl. No.: 15/823,578

(22) Filed: Nov. 28, 2017

Related U.S. Application Data
(60) Provisional application No. 62/400,805, filed on Sep. 28, 2016.
(60) Provisional application No. 62/400,936, filed on Sep. 28, 2016.

(51) Int. Cl. C04B 28/18; C04B 16/08; C04B 16/06; C04B 14/06; C04B 24/26; E04C 2/288; B32B 13/04; B32B 13/02

(52) U.S. Cl. CPC C04B 28/18; C04B 16/08; C04B 16/0633; C04B 14/06; C04B 2111/00612; E04C 2/288; B32B 13/04; B32B 13/02; C04B 24/2641

(57) ABSTRACT

Various cement-containing compositions are disclosed, including insulating cement, forms, and prefabricated building materials produced from cement-containing compositions with insulating properties. Some of the preferred embodiments include expanded polystyrene and an acrylic component to provide enhanced insulating properties, or have a lower density, lighter weight, and increased insulating R-value in comparison with other cement-containing compositions.

### REFERENCE TO RELATED APPLICATION(S)

This application for patent claims the priority of the prior-filed U.S. Provisional Patent Application 62/400,805 and 62/400,936, both filed on Sep. 28, 2016.

### FIELD OF THE INVENTION

The present disclosure relates generally to the field of cement-containing compositions, articles of manufacture, and related methods. More particularly, the present invention is directed to Insulated Concrete Forms (ICF's), insulating concrete for making such forms, and molds therefor, as well as prefabricated building materials such as ICF wall panels, etc., produced from cement-containing compositions with insulating properties.

### BACKGROUND OF THE INVENTION

Concrete and the concrete structures made from it typically include four primary components: cement (e.g., Portland cement), sand, gravel, and water. However, articles of manufacture made from only these components have limited utility due to several factors. Structural forms such as concrete walls and barriers have relatively high densities and weight. The increased weight of high-density forms can be problematic in many instances. For example, weight is always a concern in high rise construction and low load structural framing applications. Concrete only forms are known to provide insufficient insulation properties for residential purposes. In addition, such forms typically have insufficient compression or tensile strength for particular applications. For example, the prefabricated concrete only forms may be difficult to transport, because they are often brittle and inflexible even to slight degrees of bending. The ICF construction technique reduces weight, cost, and handling/manufacturing difficulty, and increases the variability of the insulating properties as compared to concrete.

First developed in Europe following World War II as an inexpensive and durable way to rebuild damaged structures. The first patent for an insulated stay-in-place form-work for concrete was registered in the early 1940s using recycled waste wood and cement as the insulating material. This patent was registered by August Schnell and Alex Bosshard in Switzerland. The first polystyrene ICF forms were developed in the late 1960s with the expiration of the original patent and the advent of modern foam plastics. Canadian contractor Werner Gregori filed the first patent for a foam concrete form in 1966 with a block “measuring 16 inches high by 48 inches long with a tongue-and-groove interlock, metal ties, and a waffle-grid core.”

The adoption of ICF construction has steadily increased since the 1970s, though it was initially hampered by lack of awareness, building codes, and confusion caused by many different manufacturers selling slightly different ICF designs rather than focusing on industry standardization. ICF construction is now part of most building codes and accepted in most jurisdictions in the developed world.

ICF walls are typically constructed one row at a time, usually starting at the corners and working toward the middle of the walls. End pieces are shaped to fit so as to waste the least material possible. As the wall rises, segments are staggered to avoid long vertical seams that can weaken the form-work. Structure frames known as bucks are placed around openings to give added strength to the openings and to serve as attachment points for windows and doors.

Interior and exterior finishes and facades are affixed directly to the ICF surfaces, depending on the type of ICF. Brick and masonry facades require an extended ledge or shelf angle at the main floor level, but otherwise no modifications are necessary. Interior ICF wall surfaces must be covered with drywall panels or other wall coatings.

Plumbing and electrical conduit can be placed inside the forms and poured into place, though settling problems could cause pipes to break, creating costly repairs. For this reason, plumbing and conduit as well as electrical cables are usually embedded directly into the form before the wall coverings are applied.

Until now insulating concrete, insulated concrete-containing forms, and the useful laminate structures made from the novel ICF panels disclosed and described herein have not been invented.

### SUMMARY OF THE INVENTION

The present invention can be summarized in a variety of ways, one of which is the following: a cement containing wall composition comprising a first cement containing form; a second cement containing form substantially parallel to and spaced apart from the first form; a cement layer inter-positioned between and bonded to the first and second forms establishing a laminate structure therewith.

In a preferred embodiment the density of the cement layer is greater than the density of either the first form or the second form, and either of the first form and second form is a pre-fabricated panel made of insulating concrete having an R value greater than the cement layer. Alternatively, the density of the cement layer is greater than the density of both the first and second forms.

For added insulating performance the first or second form further comprises one or more of expanded polystyrene, perlite, vermiculite, and fly ash; and one or more of acrylic enamel, acrylic urethane, and acrylic lacquer. Preferably the expanded polystyrene comprises polystyrene beads or pellets of less than 80¼ inch in diameter, and the one or more of acrylic enamel, acrylic urethane, and acrylic lacquer are less than 5% of the cement-containing wall composition by volume. In addition, natural organics substances can also be added for lower cost, including one or more of calcium oxide, silica, sand and gravel.

In low density, high insulating and lightweight applications, the first cement containing form or second cement containing form has a resistive strength of greater than 700 psi, but it can be as low as 300-400 PSI in ornamental or artistic molded applications produced from molds having complex curves and radiuses instead of corners. In these applications, for example, the ratio of expanded polystyrene to cement is greater than 3:1 by volume.

Additionally a variety of chemicals can also be added to reduce curing (hardening) times, release of the mold after the cement is cured, or add hardness to name a few. Thus, the cement containing forms may further comprise one or more of ether, methylene chloride, methyl ethyl ketone, 1,3,-diethenyl benzene, benzene, ethyl benzene, heptane, 1,3,5-trimethylbenzene, 1,3,5-trimethylbenzene mesitylene, alcohols (e.g., methanol, ethanol, etc.), methylcyclohexane, naphtha, naphthalene, gasoline, propane, petroleum resins, Stoddard solvent, triethanolamine, toluene, and xylene.

The chemical additive(s) may be applied in any suitable manner. For example, the chemical additive(s) may be poured into the mixture. In other embodiments, the chemical additive(s) are sprayed on the mixture. Alternatively, additives may also be sprayed onto the expanded polystyrene, which is then added to the cement. Spraying of the chemical additive(s) may improve distribution of the chemical additives throughout the mixture. In other words, spraying of the chemical additives into the mixture may result in a more uniform mixture.

Timing of the additives is sometimes crucial. Depending upon the chemical and its characteristics, the chemical additive(s) are added to the mixture no more than three hours, two hours, one hour, 30 minutes, 15 minutes, and/or five minutes before placing the cement-containing composition into a mold to produce a cement-containing form.

The method of the present invention can be summarized in a variety of ways, one of which is the following: a method of forming a cement containing insulated wall laminate, the method comprising the steps of obtaining at least two wall forms partially comprised of expanded polystyrene and cement, and one of the at least two wall forms establishes an exterior of the completed wall; positioning the at least two wall forms adjacent one another to form a mold including a cement receiving space between the at least two wall forms; pouring a flowable cement into the cement receiving space; and hardening the flowable cement to form a solid while bonding to at least one of the at least two wall forms.

The preferred method may also include a hardening step further comprising bonding the hardening flowable cement to both of the at least two wall forms positioned adjacent one another thereby forming a 3 layer laminate structure having the exterior completed wall and an interior completed wall ready for ornamental covering.

The at least two wall forms partially comprised of expanded polystyrene and cement with a cement based layer interpositioned there-between may further comprise at least one of an acrylic component, an ether, methylene chloride, methyl ethyl ketone, 1,3,-diethenyl benzene, benzene, ethyl benzene, heptane, 1,3,5-trimethylbenzene, 1,3,5-trimethylbenzene, mesitylene, alcohol, methylcyclohexane, naphtha, naphthalene, gasoline, propane, petroleum resins, Stoddard solvent, triethanolamine, toluene, and xylene to form a mixture. The mixture is the placed into the cement receiving space of the mold. The mixture is compressed forcing the mixture into bonding communication with at least one of the adjacent walls, and drying the mixture within the mold.

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

The insulating concrete of the present invention can be summarized in a variety of ways, one of which is the following: an insulating concrete made with a cement composition, comprising one or more of expanded polystyrene, perlite, vermiculite, and fly ash; and one or more of acrylic enamel, acrylic urethane, and acrylic lacquer.

Preferably, the ratio of cement to expanded polystyrene is between 1.5:1 and 1:1.5 by volume, and may be as high as between 1:10 and 1:4 by volume, and the expanded polystyrene comprises polystyrene beads or pellets are less than ¼ inch in diameter. In addition, the preferred insulating cement composition has an R-value greater than the R-value of a composition that differs from the composition only in that the one or more of expanded polystyrene, perlite, vermiculite, and fly ash are replaced with an equivalent volume of sand.

Resistive strength for compression of the cured insulating concrete can be of greater than 2000 pounds per square inch (psi), greater than 3000 psi, and/or greater than 4000 psi depending upon the application after taking into consideration the size, weight, and insulating effectiveness, etc., desired for the application or function.

In addition, the expanded polystyrene used in making the cement containing form is a closed-cell foam provided in the form of granules, pellets, or beads. For example, the expanded polystyrene of the cement containing form is provided as beads, pellets, or granules of less than ¼ inch in diameter. The expanded polystyrene can be sourced from Styrofoam waste.

The cement of the cement-containing form of alternate embodiments is a cement that comprises calcium oxide and silica. For example, the cement of the cement-containing form is Portland cement (e.g., Type I, Type II, or Type III). Other suitable cements include Class A cement, high-performance Class H cement, or hydraulic cement. In other embodiments, a cement substitute may be used, such as masonry cement, mortar, polymer-modified mortar (e.g., Ultraflex® 2), grout, plaster, or plaster substitutes.

The cement-containing composition is then placed in the mold and compressed. Compression increases the strength of the form, creates a smooth finish, and helps waterproof the end product. For example, the mixture is compressed approximately 20%-30%. Suitable molds may be made from hard plastic, aluminum, or steel. One or more release agents, such as vegetable oil, may be applied to an interior surface of the mold to promote release of the resulting wall.

### BRIEF DESCRIPTION OF THE DRAWINGS

The written disclosure herein describes illustrative embodiments that are nonlimiting and non-exhaustive. Reference is made to certain of such illustrative embodiments that are depicted in the figures, in which:

FIG. 1 is a perspective view of cement-containing forms for use in constructing walls.

FIG. 2 is a partially cutaway perspective view of the cement-containing forms of FIG. 1.

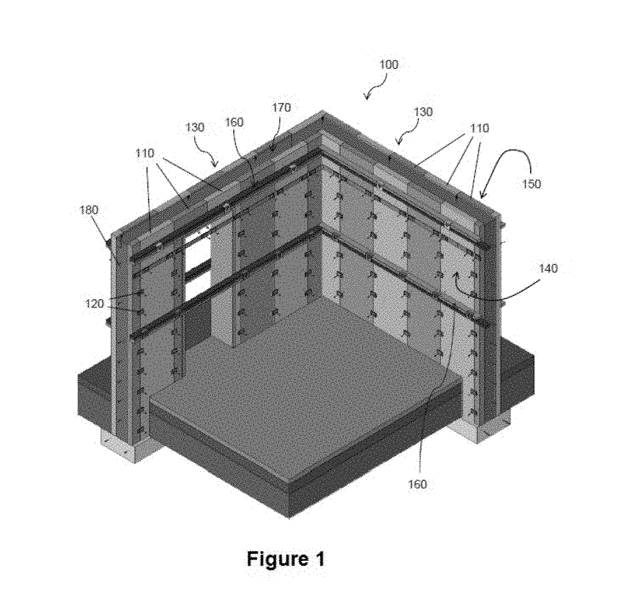

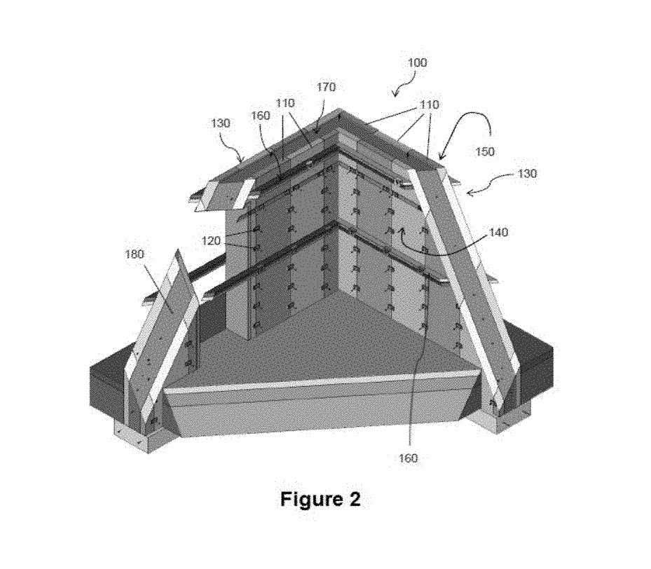

A skilled artisan will recognize that the cement-containing forms 110 and related structures depicted in FIGS. 1 and 2 are exemplary, and do not limit this disclosure.

### DETAILED DESCRIPTION

The following detailed description of various embodiments is not intended to limit the scope of the present disclosure, but is merely representative of various embodiments. The present disclosure relates generally to the field of cement-containing forms and related methods. More particularly, some of the embodiments relate to cement-containing forms with insulating properties.

An exemplary embodiment of a structure 100 formed by cement-containing forms 110 is shown in FIGS. 1 and 2. More particularly, FIG. 1 provides a perspective view of the structure 100, while FIG. 2 provides a partially cutaway perspective view of the same structure 100.

As shown in FIGS. 1 and 2, the structure 100 may include a plurality of cement-containing forms 110. The cement-containing forms 110 may be coupled to one another via ties 120 to form one or more walls 130. In the depicted embodiment, the walls 130 are formed from a first set of cement-containing forms 110 that form an interior surface 140 and a second set of forms that form an exterior surface 150. Bracing 160 may be used to ensure alignment of the walls 130. A cement-containing composition 170 is then be poured between the outer cement containing forms 110 and the inner cement-containing forms 110. Rebar 180 or other reinforcing material may be used to increase the strength of the cement-containing composition 170. The cement-containing forms 110 remain in place after the cement-containing composition 170 has dried. The cement-containing forms 110 thus may form an interior surface 140 and an exterior surface 150 of a wall 130.

Once the forms have cured, grooves can be cut into the forms to run electrical wire for electrical needs. The grooves can then be filled in with grout. Plumbing may also be installed. For example, a high-speed router with a carbide bit and laser pointer can be used to ensure that there is an accurate and straight groove. Windows and door frames can also be mounted into the forms using screws and other fasteners. Exterior surfaces (e.g., brick, stone, wood, stucco) can be applied to the forms without any additional support. In some circumstances, one or more finishes may be applied to interior or exterior of the forms.

The resulting forms can have a density that is less than 50%, less than 40%, less than 30%, and/or less than 20% of traditional concrete. For example, a 12′×3.5″×4′ form is approximately 100 pounds. Forms having a wide variety of dimensions can be manufactured as desired.

Wiring and/or plumbing may be installed in a cement-containing form without the need for interior framing. In other words, some cement-containing forms do not require interior framing for exterior and/or interior walls. Windows and/or doors can also be secured within the cement-containing forms. Of course, the cement-containing forms may be adjusted for grade elevation changes. The cement-containing forms described herein can allow for the simultaneous construction of several floors. The cement-containing forms described herein can also reduce the amount of waste per job due to different size walls, pitches, and angles, as well as wood waste from interior framing. The cement-containing compositions described herein generally do not burn (i.e., are fireproof), enhancing safety. The cement-containing compositions described herein may allow for insertion of rebar according to specific job needs, and need not limit the position of rebar to specific preset distances. The cement-containing compositions described herein can reduce or eliminate the need for metal forms. Labor can also be reduced as there may be no need to remove the cement-containing forms once the cement has set (e.g., approximately three days under normal conditions).

Some cement-containing forms described herein can be used to form nonstructural interior walls. The ease of construction of such non-structural interior walls may reduce or eliminate the need for interior framing of a building, as electrical wiring can be routed into the cement form or have conduits put right into the walls when they are being made. Some cement-containing forms described herein can be used to make an insulating structural wall.

Insulated cement-containing forms can be used to pour concrete walls. Generally, the cement-containing forms become a permanent part of the resulting wall. In other words, the forms stay in place as a permanent part of the wall assembly.

Some cement-containing forms may be pre-formed interlocking blocks or separate panels connected by ties (e.g., plastic ties). The left-in-place forms may provide a continuous insulation and sound barrier. The forms may also supply (1) a backing for drywall or other finishes on the side surface of the wall and/or (2) a backing for stucco, lap siding, brick, etc. on the outside.

Insulated cement forms can differ widely in the details of their shapes, cavities, and component parts. Block systems generally have the smallest individual units. The individual units of block systems may have any suitable size, such as 8″×1′4″ to 1′4″×4′. Atypical block is 10″ in overall width, with a 6″ cavity for the concrete. The blocks may be designed to fit with one another via special interlocking edges that fit together like plastic children's blocks.

Panel systems generally have relative large individual units, ranging from roughly 1′×8′×3″ to 4′×12′×3″. The edges of the panel systems may be flat. The panels may be interconnected by attachment of a separate connector or “tie.” Panels are generally assembled into units either on site or by the local distributor prior to delivery. Plank systems are similar to panel systems, but generally use smaller faces of foam, ranging in height from 8″ to 12″ (or more) and in length from 4′ to 8′ (or more). The major difference between planks and panels is the method of assembly. The foam planks are outfitted with ties as part of the setting sequence, rather than pre-assembled into units.

Insulated cement forms can vary in the design of their cavities. “Flat wall” systems yield a continuous thickness of concrete, like a conventional poured wall. “Waffle grid wall” systems have a waffle pattern where the concrete is thicker at some points than others. “Screen grid” systems have equally spaced horizontal and vertical columns of concrete which are completely encapsulated in polystyrene or engineered polymer.

As used herein, the term “cement-containing form” refers to a form that is made from a cement-containing composition. The term does not encompass forms that are used for shaping a cement-containing composition when the form itself is not made from a cement-containing composition.

### DETAILED DESCRIPTION

The following detailed description of various embodiments is not intended to limit the scope of the present disclosure, but is merely representative of various embodiments. The present disclosure relates generally to the field of cement-containing compositions and related methods. More particularly, some of the embodiments relate to cement-containing compositions with insulating properties.

Concrete typically includes four primary components: cement (e.g., Portland cement), sand, gravel, and water. However, structures made from only these components have limited utility due to several factors.

First, such concrete structures have relatively high densities. The increased weight of such high-density structures can be problematic in many instances. Second, such concrete structures may provide insufficient insulation properties for some purposes. Third, such concrete structures may have insufficient compression or tension strength for particular applications. Certain embodiments disclosed herein can address one or more of these deficiencies.

The cement-containing composition may include cement and one or more of expanded polystyrene, perlite, vermiculite, and fly ash. For example, the cement-containing composition preferably includes expanded polystyrene (e.g., Styrofoam). The inclusion of low-density aggregate, such as beads of expanded polystyrene, lowers the density of the resulting aggregate cement-containing structure. The inclusion of expanded polystyrene embues the resulting structure with increased insulation properties. In other words, the resulting structure IS a better insulator than concrete that universally lack expanded polystyrene or other low-density aggregate.

In some embodiments, the ratio of cement to expanded polystyrene or other low-density aggregate is between 1:10 and 10:1 by volume. For example, the ratio of cement to expanded polystyrene is between 1:10 to 1:4, such as between 1:8 to 1:5 by volume. In other embodiments, the ratio of cement to expanded polystyrene is between 1.5:1 and 1:1.5 by volume. Polystyrene is between 45% and 85%, between 45% and 65%, between 65% and 85% or between 55% and 75% by volume of the cement-containing composition. In some embodiments, polystyrene is less than 45% of the cement-containing composition by volume.

In a preferred embodiment, 87% of the product is recycled Styrofoam and Polypropylene fibers and a small amount of user specified chemicals. The weight is about 1/10th that of concrete. Equipment used would involve a mixer, a conveyor that would allow the Styrofoam to have a coat of cement mixture icing and plastic strands upon it, and a mold for curing.

The expanded polystyrene used may be a closed-cell foam composition that is provided in the form of granules, pellets, or beads. For example, the expanded polystyrene of the cement-containing composition is provided as pellets, beads, or granules of less than ¼ inch in diameter. The expanded polystyrene can be sourced from Styrofoam waste.

In other embodiments, the cement of the cement-containing composition comprises calcium oxide and silica. For example, the cement of the cement-containing composition is Portland cement (e.g., Type I, Type II, or Type III). Other suitable cements include, but are not limited to, Class A cement, high performance class H cement, or hydraulic cement. A cement substitute may also be used, such as masonry cement, mortar, polymer-modified mortar (e.g., Ultraflex® 2) grout, plaster, or plaster substitutes. The cement is between 15% and 55%, between 30% and 45%, between 15% and 35%, or between 35% and 55% of the cement-containing composition by volume.

The cement-containing composition may further include one or more acrylic components, such as acrylic enamel, acrylic urethane, and acrylic lacquer depending upon the application. The acrylic component may interact with (e.g., partially dissolve) a relatively low-density material, such as expanded polystyrene, to improve the structural characteristics of the resulting cement-containing structure.

For example, the acrylic component may interact with the expanded polystyrene to improve adhesion between the expanded polystyrene and the cement, thereby producing a cement-containing structure with increased structural integrity. In some embodiments, the acrylic component of the cement-containing composition is less than 5% and/or less than 2% of the cement-containing composition by volume. For example, the acrylic component is between 0.5% and 2% by volume of the cement-containing composition.

Some preferred compositions include an acrylic hardener, such as acrylic urethane hardener, or even a polymer. The hardener may help set the end product to a greater strength and/or lower volatile organic compound emission, thereby enabling compliance with emission standards. The cement-containing composition may include one or more polymer-based sealers, such as KSC Komponent®. KSC Komponent® includes silicone dioxide (7.70%), aluminum oxide (7%), iron oxide (1.17%), calcium oxide (50.06%), magnesium oxide (0.08%), sulfur trioxide (26.04%), total alkalis such as Na₂O (0.56%), and insoluble residue (2.38%). Sealers may decrease cracking and increase flexibility of the cement-containing composition. Such sealers also reduce cracking as the composition is heated, and improve the insulation and/or the strength of the composition. A type-K cement is one such sealer. The sealer may accelerate drying time, close pores on the cement, prevent cracking, and/or allow the cement to expand or contract. The expansion of type-K cement, when mixed with sufficient water, may be primarily due to formation of the crystal ettringite. Hydraulic cements and carbon-enhanced cement may be added (from 1%-10%). Such sealers may allow the product to flex up to ¼ inches without cracking as it cures.

In other embodiments, the cement-containing composition may include hard polypropylene fibers (typically less than 1% by volume). Such fibers can add vertical and/or horizontal structure. Carbon metal fibers, titanium fibers, stainless steel metal fibers, or other metal fibers or shavings can additionally or alternatively be added for strength.

When used, the amount of sand and/or gravel in the cement containing composition is typically less than 25%, less than 20%, less than 15%, less than 10%, and/or less than 5% sand and/or gravel. Limiting the amount of sand and/or gravel in the cement-containing composition may reduce the density of the cement-containing composition.

The cement-containing composition provides increased insulation properties relative to other common cement-containing compositions. For example, some cement-containing compositions described herein may have an R-value that is greater than the R-value of a composition that differs from the cement-containing composition only in that the polystyrene (or other low-density material) is replaced with an equivalent volume of sand or gravel.

A water-proofing agent, such as particular silanes (e.g., triethoxycapryltylsilane in Rheopel Plus™), may be applied to the resulting cement-containing structure to improve resistance to water. Compression may also further waterproof the cement-containing composition. Water may be added to yield a cement-containing composition of the desired consistency. Such consistency may be determined by the concrete slump test, or by any other suitable method.

In use, the cement-containing composition may be dried to a moisture condition appropriate for its ultimate intended use. For example, the cement-containing composition may be the product formed by introducing a wetted composition into a form or other container and then drying and/or curing the material in the form or container.

To manufacture a cement-containing structure, expanded polystyrene (or some other low-density material with insulation properties) may be added to cement to form a mixture of cement and expanded polystyrene. Subsequently, an acrylic component, such as acrylic enamel, acrylic urethane, or acrylic lacquer, may be added to the mixture that includes cement and the low-density material (e.g., expanded polystyrene) and mixed therein. The acrylic component may partially dissolve the expanded polystyrene. The acrylic component may be applied to the mixture in any suitable manner. For example, the acrylic component is poured into the mixture. In other embodiments, the acrylic component is sprayed on the mixture.

Spraying of the acrylic component onto the mixture may improve distribution of the acrylic component throughout the mixture. In other words, spraying of the acrylic component into the mixture may result in a more uniform mixture. The acrylic component is added (e.g., poured or sprayed) to the expanded polystyrene before the polystyrene is mixed with the cement and poured onsite. In some circumstances, the cement-containing composition is delivered into a form or container relatively soon after addition of the acrylic component. For example, in a preferred embodiment the acrylic component is added to the mixture no more than three hours, two hours, one hour, 30 minutes, and/or 15 minutes before placing the cement containing composition into a form.

Additionally, the cement-containing composition may be compressed. Such compression may increase the strength of the cement-containing composition, create a smooth finish, and/or help waterproof the composition. For example, the mixture is compressed approximately 20%-30%. An augur mixer may be used in some instances. Use of an augur may result in a more even distribution of material within the mixture. For example, use of an augur may create a substantially homogeneous mixture of cement, polystyrene, and any other component in the mixture. For example, components may be uniformly distributed or dispersed within the cement.

In other or further embodiments, the cement-containing compositions described herein may be used for pilings, foundations, slabs, sealing, adding structural integrity, and to manufacture a cement-containing form into which concrete or other cement-containing material may be poured. Ultraflex®, such as Ultraflex® 2, crystalline silica and/or silica sand, epoxy and enamels, a vinyl polymer, silicone resin(s), or triethoxycaprylylsilane can be added to the cement-containing composition to improve insulation and integrity of the finished product. For example, the cement-containing composition is used to form y.

The cement-containing forms of the present invention are extremely useful and easy to work with. The cement-containing compositions can be used to create non-structural interior walls. Such walls may be made from approximately 30% cement (+10%), 70% expanded polystyrene (+10%), and 3% chemical additives (+2%) (e.g., acrylic components). In some embodiments, the mixture is compressed approximately 20% (+10%) during formation of non-structural interior walls. In other words, a cement-containing composition can be introduced into a mold and then compressed (e.g., more cement can be added).

A release agent (e.g., vegetable oil) may be applied to the mold to facilitate release of the wall. The product can be moved on site and tilted up to form an interior wall. The ease of construction of such nonstructural interior walls may reduce or eliminate the need for interior framing of a building, as electrical wiring can be routed into the cement form or have conduits put right into the walls when they are being made. The cement-containing compositions described herein can be poured into cement-containing forms.

The cement-containing compositions can also be used to form roofing tiles. Such roofing tiles may use 25%-50% cement and 50%-75% expanded polystyrene. Roofing tiles may include sand. An example of a formula for roofing tile includes cement, silicone sand, Ultraflex® 3, Komponent® (5%-10% by volume), resins, polymer pellets such as expanded polystyrene (55%-65% by volume), non-calcium chloride (0.4% by volume), ether, one or more acids, one or more bases oil-based concrete release agent, lacquer or grout sealer. Exemplary additives include acetic acid ethenyl ester, N-butyl acetate, 1-methoxy-2-propyl acetate, 2-butoxyethyl

acetate, D-limonene, and muriatic acid. Exemplary bases or other compounds for inclusion in a mixture for forming an insulating cement include dilute red phosphorus, lye, lime, or any suitable base having a pH greater than 9. One or more acrylic components (e.g., an acrylic enamel, an acrylic urethane, an acrylic lacquer) may be used to form roofing tiles. The tiles are formed by extrusion. In other embodiments, the tiles are molded and then compressed. A sheet of this same material can also be placed between plywood and chip board that is used for roofing.

To form roofing tiles, cement and water may be mixed in the conventional fashion to form a slump. Dry ingredients may then be added and mixed with an augur. The expanded polystyrene (or a mixture containing expanded polystyrene) may then be sprayed with chemical additives that break it down, such as ether/alcohol mix. Other binders, sealers, breakdown chemicals, etc. may also be added. Some roofing tiles may use fibers, which may tend to make the tiles less waterproof. A row of webbing may be applied to the back of the tiles so that the tiles will stick to the grout better. Tiles may be extruded from an extruder machine. The tiles may then set (10 or more minutes) and then cure (approximately 24 hours).

One or more additives may be used to help keep the concrete from freezing (e.g., lower the freezing point) and/or to help the concrete set faster. For example, some cement-containing compositions include a calcium-containing composition. Examples include calcium stearate, calcium carbonate, calcium chloride, and calcium oxidate. Non-calcium chloride may also be used. Mixes that contain one or more of these ingredients may also be used. Calcium can influence the speed at which the product sets up. Calcium can also slow freezing of the product. Calcium may also help other chemicals encapsulate the cement pores, preventing them from taking on water once the mixture has set. Lime, a form of calcium, may also break it down.

Other common or exotic additives may also be used in connection with the cement containing compositions described herein provided they add some additional benefit or attribute. For example, a superplasticizer (also known as high-range water reducers) may be used as a dispersant to avoid particle segregation, and to improve the flow characteristics (rheology) of suspensions. The addition of superplasticizers may allow for a reduction of the water-to-cement ratio without affecting the workability of the mixture. Such plasticizers may additionally or alternatively enable the production of self consolidating concrete and high-performance concrete. One such superplasticizer is Verifi®.

Additionally, the cement-containing form may include hard polypropylene fibers (typically less than 1% by volume). Such fibers can add vertical and/or horizontal structure. Carbon metal fibers, titanium fibers, stainless steel metal fibers, or other metal fibers or shavings can additionally or alternatively be added to strengthen the forms. The fibers and/or shavings increase the holding power of the forms for nails, screws, or other fasteners. A fiber mat may also be applied to the cement-containing form.

The density of the cement-containing form is less than the density of a form that differs from the cement-containing form only in that the expanded polystyrene (or other low-density material) is replaced with an equivalent volume of sand. In some embodiments, the density of the cement-containing form is less than the density of solid steel, aluminum, and/or wood.

The cement-containing composition is a solid (e.g., cured or hardened) composition that has a resistive strength for compression that is greater than 300, 400, 500, 600, 700, 1000, 2000, 3000, 4000, and/or 5000 pounds per square inch (psi) depending on the application.

### Example 1—Interior Wall

A cement-containing composition for an interior wall was prepared by mixing Styrofoam (14 L), soft polypropylene fibers (1 g), hard fibers (1 g), cement (6 L), Komponent® (0.2 L), non-calcium chloride (0.2 L), and ether (0.2 L). Two liters of water were also used.

### Example 2-Roofing Tiles

Cement (900 ml), silicone sand (100 ml), epoxy (150 ml), and expanded polystyrene (6000 ml) were mixed with water to form a mixture that was used for roofing tiles. This same mixture can be placed into cement-containing forms if desired.

### Example 3—Insulated Cement

The following components were mixed: expanded polystyrene (8 L), ether (0.010 ml), concrete (2.5 L), non-calcium chloride (2.5 L), Komponent® (0.6 L), acrylic enamel (0.25 L), cement (0.5 L), and sand (0.5 L), with 3 L of water to form a cement-containing composition.

### Example 4—Insulated Cement

The following components were used make a cement-containing composition: cement (4 L), 5-star acrylic urethane (0.3 L), 5-star acrylic urethane hardener (1.875 L), DAU 75 (0.1 L), Komponent® (0.2 L), expanded polystyrene (6 L), silicone (0.2 L), and silicone sand (3 L). The resulting cement-containing composition, when cured, had a resistive strength of 5450 psi.

### Example 5—Insulated Cement

The following components were used make two cement-containing compositions: Portland cement (2.1 L), DAU 75 (0.2 L), DAU hardener 6/100 DXR80 (0.013 L), expanded polystyrene (2.5 L), and silicone sand (1.5 L). In the first cement containing composition, the expanded polystyrene was 0.25 inches in diameter. In the second cement-containing composition, the expanded polystyrene was a much smaller bead. The resulting cement-containing compositions had, when cured, resistive strengths of 973 psi (the first composition) and 4120 psi (the second composition).

### Example 6—Insulated Cement

The following components were used make a cement-containing composition: Portland cement (2.1 L), DAU 75 (0.1 L), DAU hardener 6/100 DXR80 (0.006 L), dry block (0.016 L), non-calcium chloride (0.05 L), expanded polystyrene (3 L), silicone (0.1 L), and silicone sand (1.5 L). The resulting cement-containing composition had, when cured, a resistive strength of 1818 psi.

### Example 7—Insulated Cement

The following components were used make a cement-containing composition: Portland cement (4 L), DAU 75 (0.24 L), DAU hardener 6/100 DXR80 (0.015 L), dry block (0.15 L), Komponent® (0.2 L), expanded polystyrene (5 L), and silicone sand (3 L). The resulting cement-containing composition had, when cured, a resistive strength of 1270 psi. The use of dry block in this and other embodiment may significantly weaken the strength of the end product.

### Example 8—Insulated Cement

The following components were used make a cement-containing composition: 70% alcohol (0.2 L), Portland cement (4.5 L), DAU 75 (0.03 L), DAU hardener 6/100 DXR80 (0.001875 L), diamond hard (0.2 L), MA-455 activator (0.02 L), expanded polystyrene (6 L), and silicone sand (5.5 L). The resulting cement-containing composition had, when cured, a resistive strength of 1530 psi.

### Example 9—Insulated Cement

The following components were used make a cement-containing composition: Styrofoam (20 L), cement (9.8 L), Komponent® (0.784 L), lime (0.5 L), sand (0.75 L), MS 747 clear coat (0.05 L), MA activator (0.0125 L), HR 0870 reducer (0.040 L), soft fibers (0.0005 L), hard fibers (0.0005 L), and KILZ semi-gloss acrylic enamel (0.1 L). The result cement-containing composition had, when cured, a resistive strength of between 580 psi and 610 psi.

### Example 10—Insulated Cement

The following components were used make a cement-containing composition: Styrofoam (40 L), cement (16 L), Komponent® (0.6 L), sand (12 L), lime (0.4 L), clear coat (0.1 L), activator (0.025 L), water acrylic enamel (0.050 L), and 12 L of water. The resulting cement-containing composition, when cured, had a resistive strength of between 305 psi and 355 psi.

### Example 11—Cement-Containing Form

A cement-containing form was manufactured by combining expanded polystyrene (12 L), soft fiber (1 cup), cement (2.37 L), Komponent® (1.2 L), and sand (500 ml). Approximately 1.5 L of water was used. The resulting mixture was used to create a form panel (without compression). The form panel had a resistive compression strength of 760 psi.

### Example 12-Cement-Containing Form

A cement-containing form was manufactured by combining expanded polystyrene (25 L), soft polymer fiber (0.5 oz), cement (4.5 L), Komponent® (1 L), and non-calcium chloride (500 ml). Approximately 2.5 L of water was used. The resulting mixture was used to create a form panel (without compression). The form panel had a resistive compression strength of 740 psi, and after 50% compression, a thermal conductivity of 0.62, and an R-value of 1.6 per inch.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated by one of skill in the art with the benefit of this disclosure that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. It will be apparent to those having skill in the art that changes may be made to the details of the above-described embodiments without departing from the underlying principles of the present disclosure.

We claim:

1. A cement containing wall composition comprising:
a first cement containing form;
a second cement containing form substantially parallel to and spaced apart from the first form;
a fill layer inter-positioned between and bonded to the first and second forms establishing a laminate structure therewith;
wherein the density of the fill layer is greater than the density of either the first form or the second form; and
either of the first form and second form is a pre-fabricated form panel made of insulating concrete having an R value greater than the fill layer.

2. The cement containing wall composition of claim 1 wherein the density of the fill layer is greater than the density of both the first and second forms.

3. The cement containing wall composition of claim 1, wherein the first or second form further comprises:
one or more of expanded polystyrene, perlite, vermiculite, and fly ash; and
one or more of acrylic enamel, acrylic urethane, and acrylic lacquer.

4. The cement containing wall composition of claim 3, wherein the expanded polystyrene comprises polystyrene beads or pellets of less than ¼ inch in diameter.

5. The cement containing wall composition of claim 3, wherein the one or more of acrylic enamel, acrylic urethane, and acrylic lacquer are less than 5% of the cement-containing panel composition by volume.

6. The cement containing wall composition of claim 1, wherein the cement comprises one or more of calcium oxide, silica, sand and gravel.

7. The cement containing wall composition of claim 3, further comprising:
expanded polystyrene wherein the first cement containing form or second cement containing form has a resistive strength of greater than 700 psi.

8. The cement containing wall of claim 7, wherein the ratio of expanded polystyrene to cement is greater than 3:1 by volume.

9. The cement containing form of claim 1, further comprising one or more of ether, methylene chloride, methyl ethyl ketone, 1,3,-diethenyl benzene, benzene, ethyl benzene, heptane, 1,3,5-trimethylbenzene, 1,3,5-trimethylbenzene mesitylene, alcohols (e.g., methanol, ethanol, etc.), methylcyclohexane, naphtha, naphthalene, gasoline, propane, petroleum resins, Stoddard solvent, triethanolamine, toluene, and xylene.

10. A method of forming a cement containing insulated wall laminate, the method comprising:
obtaining at least two wall forms partially comprised of expanded polystyrene and cement, and one of the at least two wall forms establishes an exterior of the completed wall;
positioning the at least two wall forms adjacent one another to form a mold including a cement receiving space between the at least two wall forms;
pouring a flowable cement into the cement receiving space; and
hardening the flowable cement to form a solid while bonding to at least one of the at least two wall forms.

12. The method of claim 11, wherein the hardening step further comprises the step of:
hardening the flowable cement and bonding it to both of the at least two wall forms positioned adjacent one another thereby forming a 3 layer laminate structure having the exterior completed wall and an interior completed wall.

13. The method of claim 12 further comprising the steps of:
combining the at least two wall forms partially comprised of expanded polystyrene and cement with a cement based layer inter-positioned there-between and further comprising at least one of an acrylic component, an ether, methylene chloride, methyl ethyl ketone, 1,3,-diethenyl benzene, benzene, ethyl benzene, heptane, 1,3,5-trimethylbenzene, 1,3,5-trimethylbenzene, mesitylene, alcohol, methylcyclohexane, naphtha, naphthalene, gasoline, propane, petroleum resins, Stoddard solvent, triethanolamine, toluene, and xylene to form a mixture;
placing the mixture into the cement receiving space of the mold;
compressing the mixture into the mold; and
drying the mixture within the mold.

14. An insulating concrete made with a cement composition, comprising:
one or more of expanded polystyrene, perlite, vermiculite, and fly ash; and
one or more of acrylic enamel, acrylic urethane, and acrylic lacquer.

15. The insulating concrete composition of claim 14, wherein the ratio of cement to expanded polystyrene is between 1.5:1 and 1:1.5 by volume.

16. The insulating concrete composition of claim 14, wherein the ratio of cement to expanded polystyrene is between 1:10 and 1:4 by volume.

17. The insulating concrete composition of claim 14, wherein the expanded polystyrene comprises polystyrene beads or pellets of less than ¼ inch in diameter.

18. The insulating concrete composition of claim 14, wherein the cement comprises calcium oxide and silica.

19. The insulating concrete composition of claim 14, wherein the cement composition has an R-value that is greater than the R-value of a composition that differs from the cement-containing composition only in that the one or more of expanded polystyrene, perlite, vermiculite, and fly ash are replaced with an equivalent volume of sand.

20. The insulating concrete composition of claim 14, wherein the cement composition is a cured solid composition that has a resistive strength for compression of greater than 2000 pounds per square inch (psi), greater than 3000 psi, and/or greater than 4000 psi.
